(19) United States
(12) Patent Application Publication
(10) Pub. No.: US 2023/0083118 A1
(43) Pub. Date: Mar. 16, 2023

(54) FRAUD SUSPECTS DETECTION AND VISUALIZATION

(71) Applicant: International Business Machines Corporation, Armonk, NY (US)

(72) Inventors: Steven George Barbee, Amenia, NY (US); Si Er Han, Xi'an (CN); Jing Xu, Xi'an (CN); Ji Hui Yang, Beijing (CN); Xue Ying Zhang, Xi'an (CN)

(21) Appl. No.: 17/476,401

(22) Filed: Sep. 15, 2021

(51) Int. Cl. G06Q 20/40; G06K 9/62; G06F 17/18

(52) U.S. Cl. CPC G06Q 20/4016; G06F 17/18; G06K 9/6247

(57) ABSTRACT

An approach is provided in which the approach generates anomaly score variables using multiple unsupervised models based on a set of data records. The approach normalizes the anomaly score variables into multiple normalized variables, and constructs at least one interaction based on a first one of the normalized variables and a second one of the normalized variables. The first normalized variable corresponds to a first one of the anomaly score variables and the second normalized variable corresponds to a second one of the anomaly score variables. The approach detects a set of anomalies based on the at least one interaction and transmits the set of anomalies to a user.

### BACKGROUND

Financial risk management is the practice of protecting economic value in a firm by using financial instruments to manage exposure to risk, such as operational risk, credit risk, market risk, business risk, and legal risk. Similar to general risk management, financial risk management requires identifying the risk sources, measuring the risk, and plans to address the risk. Financial risk management also focuses on when and how to hedge using financial instruments to manage costly exposures to risk.

Industries have witnessed a surge in the reliance on financial services (e.g., banking, credit cards, insurance, etc.) over the last few decades, while the advent of the Internet has led to a sharp rise in the number of online transactions. Both of these factors are driving an increase in the prevalence of financial fraud. Some of today’s approaches to detect financial fraud include data mining, which involves transaction sample analysis and adding individual labels to individual transactions that appear fraudulent.

Finding possibly fraudulent or anomalous data without known examples is a common problem in financial, security, and other applications. Because known examples are not available, today’s fraud detection systems typically use unsupervised models to detect fraudulent transactions. Today’s fraud detection systems build an unsupervised model on a data set, and then the unsupervised model assigns a score value to each of the data records that indicates how likely the data record would be an anomaly. In turn, the fraud detection system marks those data points whose score exceeds a threshold as anomalies.

### BRIEF SUMMARY

According to one embodiment of the present disclosure, an approach is provided in which the approach generates anomaly score variables using multiple unsupervised models based on a set of data records. The approach normalizes the anomaly score variables into multiple normalized variables, and constructs at least one interaction based on a first one of the normalized variables and a second one of the normalized variables. The first normalized variable corresponds to a first one of the anomaly score variables and the second normalized variable corresponds to a second one of the anomaly score variables. The approach detects a set of anomalies based on the at least one interaction and transmits the set of anomalies to a user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a fraud detection system that uses multiple unsupervised models to identify transaction anomalies based on normalized variables interaction analysis and principal component analysis (PCA);

FIG. 4 is an exemplary flowchart showing steps taken to detect anomalies based on interactions and PCA components;

FIG. 5 is an exemplary diagram depicting table data that includes data records information, score sets, normalized scores, and interactions;

FIG. 6 is an exemplary diagram depicting fraud detection system 300 transforming a normalized scatter plot using principal component analysis (PCA);

FIG. 7 is an exemplary diagram showing multiple anomaly plots based on the top m interactions and the top n components; and

FIG. 8 is an exemplary diagram depicting a combination of the anomalies detected by fraud detection system 300.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

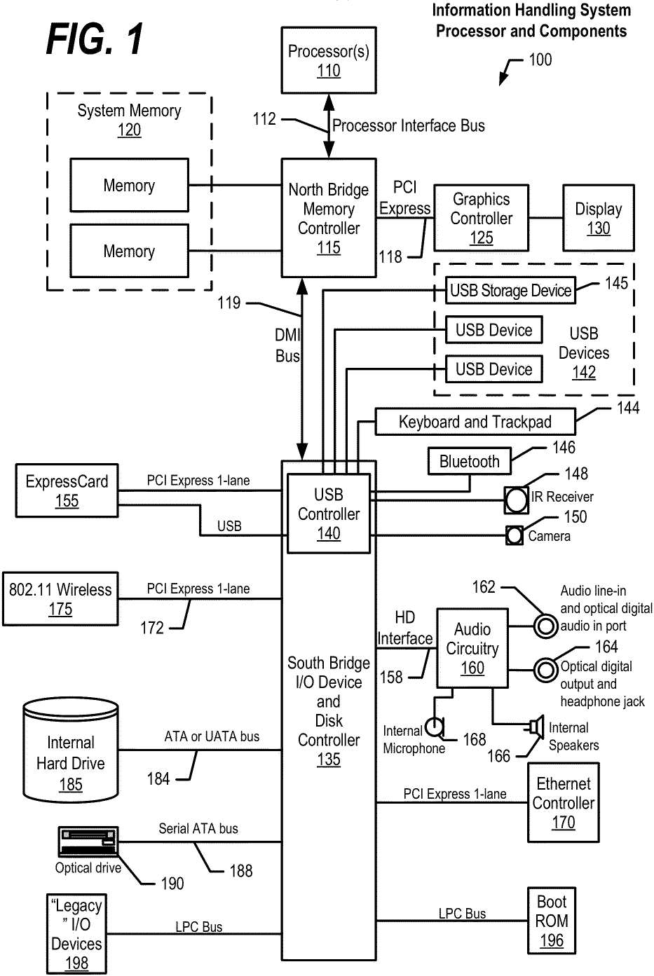

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wirelessly communicate between information handling system 100 and another computer system or device. Optical storage device 190 connects to Southbridge 135 using Serial Analog Telephone Adapter (ATA) (SATA) bus 188. Serial ATA adapters and devices communicate over a highspeed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

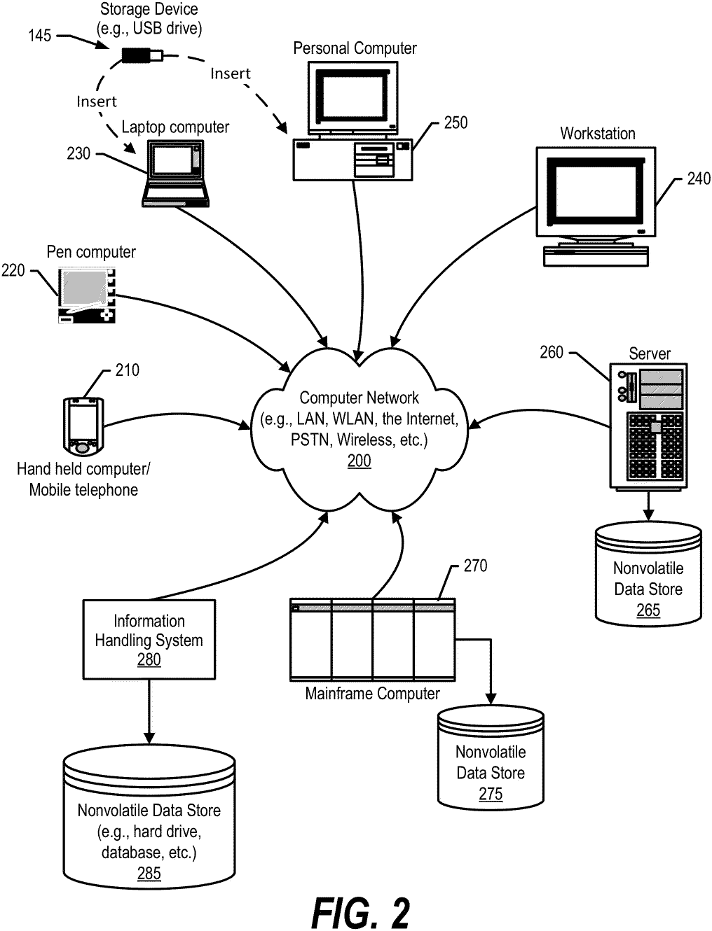

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, today’s fraud detection systems typically use unsupervised models to identify potential fraudulent or anomalous data. A challenge found with today’s fraud detection systems is that since there is no benchmark for the anomalies, it is difficult to know if one data point is a real anomaly or a false positive based on a single model. As such, some of today’s fraud detection systems use an ensemble method to detect anomalies.

The ensemble method creates multiple models and then aggregates the individual outputs of the models to produce a final result. However, a challenge found with today’s ensemble methods is that they are too simple and do not report some real anomalies because the anomalies are just on the edge of one or more model thresholds. For example, the ensemble may include three models that generate output S1, S2, and S3. In this example, today’s approaches detect anomalies from S1 (e.g., a1), then S2 (e.g., a2), and then S3 (e.g., a3). The ensemble method then aggregates the anomalies into a single anomaly list that includes a1, a2, and a3. An anomaly on the threshold edge of S1, S2, and/or S3 is not included in the aggregated list.

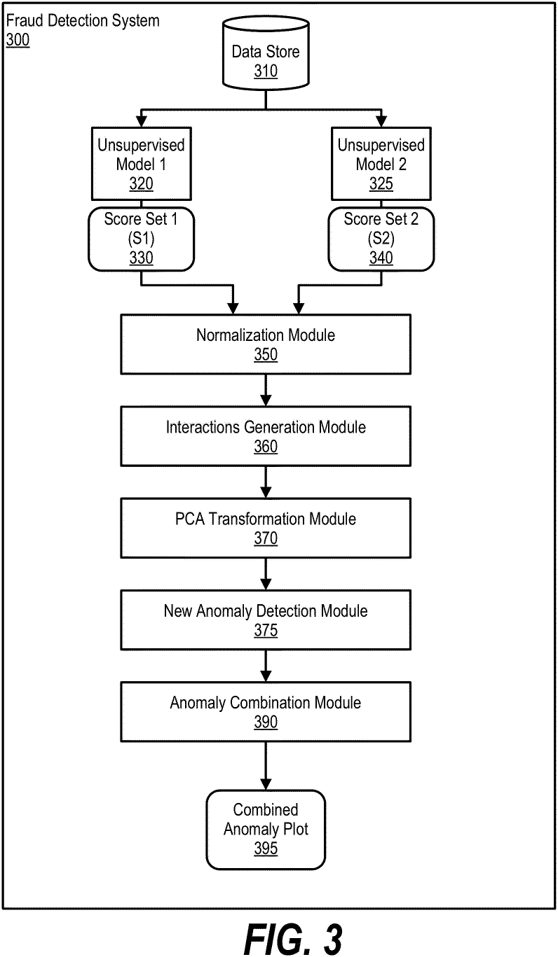

FIGS. 3 through 8 depict an approach that can be executed on an information handling system that analyzes interactions between multiple models’ outputs to detect anomalies. The approach creates useful interaction equations (referred to herein as interactions) and linear combinations of anomalous scores from multiple unsupervised models, and applies anomalies detection to the created interactions and linear combinations. In turn, the approach combines the detected anomalies and displays the detected anomalies with their corresponding detection rules for a user to analyze.

FIG. 3 is an exemplary diagram depicting a fraud detection system that uses multiple unsupervised models to identify transaction anomalies based on normalized variable interaction analysis and principal component analysis (PCA). Fraud detection system 300 creates a combined anomalies visualization and displays detection rules for anomalies selected by a user to assist the user in understanding reasons a particular data point is determined to be an anomaly.

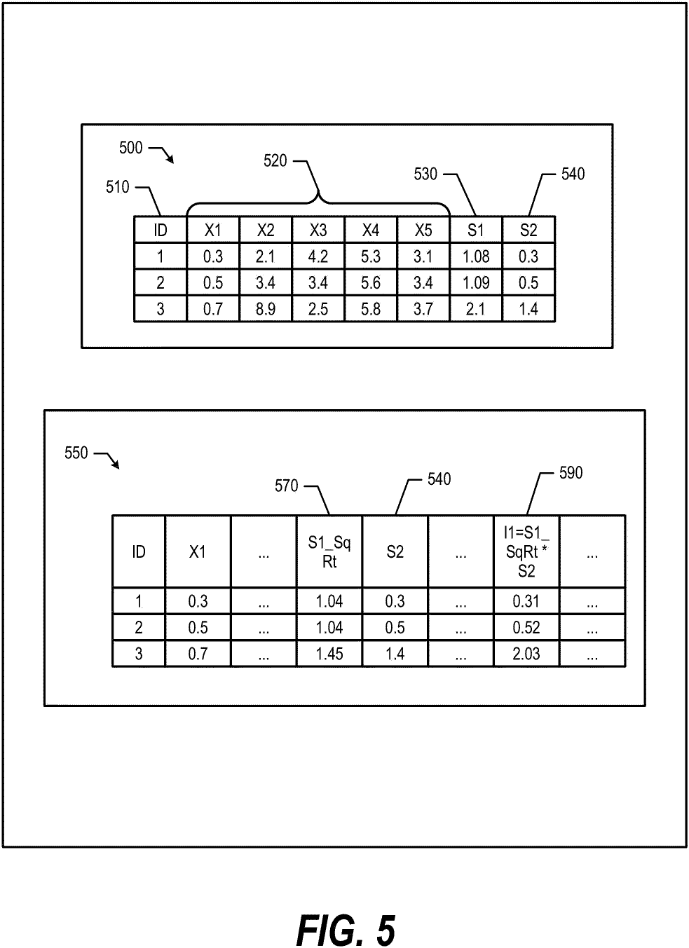

Data store 310 includes a list of data records, each of which includes multiple features (see FIG. 5, table 500 and corresponding text for further details). Unsupervised model 1 320 evaluates the data records and generates score set 1 330, which are anomaly scores for each data record based on unsupervised model 1 320’s analysis that measures how likely a data record would be an anomaly. Score set 1 330 forms as “score variable S1.”

Likewise, unsupervised model 2 325 evaluates the data records and generates score set 2 340, which are anomaly scores for each data record based on unsupervised model 2 340’s analysis that measures how likely the data record would be an anomaly (see FIG. 5, table 500, columns 530, 540, and corresponding text for further details). Score set 2 forms as “score variable S2.” In one embodiment, fraud detection system 300 includes more than two unsupervised models and each of the unsupervised models evaluates the same data records in data store 310 and generates their own individual score sets based on their own individual analysis. In this embodiment, each of the score sets from the individual analysis forms an anomaly score variable.

Score variable S1 and score variable S2 feed into normalization module 350. Normalization module 350 evaluates the score variables and determines if the score variables follow a normal distribution, such as by using a statistics test (e.g., a Kolmogorov-Smirnov (KS) test). When one or both of the score variables do not follow a normal distribution, normalization module 350 normalizes one or both of the score variables using various transformation functions such as an inverse transformation, logarithmic transformation, exponential transformation, square root transformation, etc. Although some score variables may not be transformed because they follow a normal distribution, the non-transformed score variables are still regarded herein as normalized variables with a transformation function as “Identity.” As such, all variables outputted from normalization module 350 are referred to herein as “normalized variables” and their corresponding values are referred to herein as “normalized scores.”

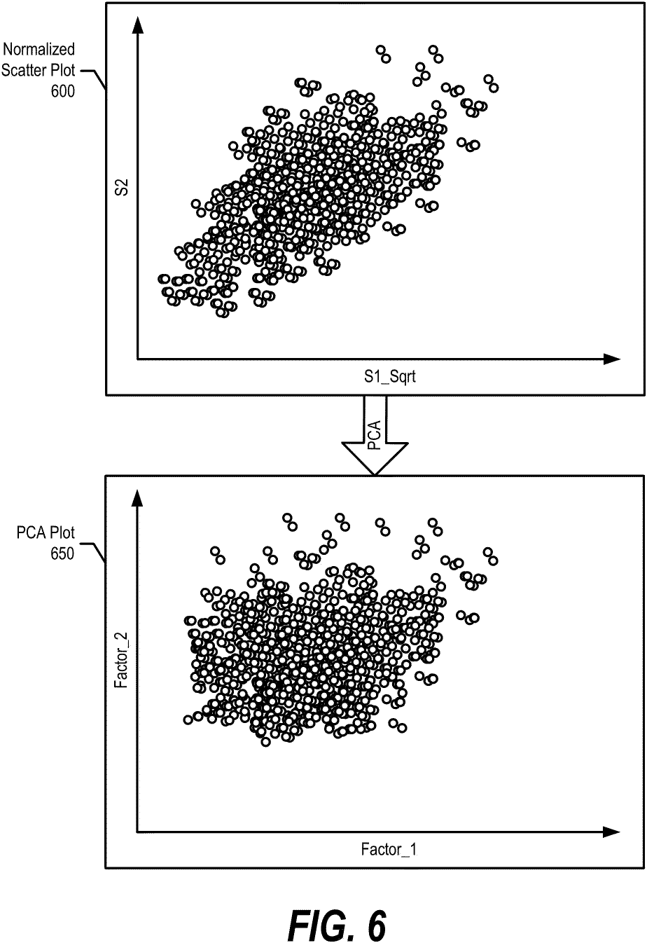

FIG. 6 shows normalized scatter plot 600 where normalization module 350 transforms score variable S1 using a square root transformation (S1_Sqrt) but does not transform score variable S2 because, in this example, fraud detection system 300 determined that score variable S2 already follows a normal distribution.

Interactions generation module 360 creates useful interactions of the normalized variables received from normalization module 350. In one embodiment, each interaction is a product of two of the normalized variables received from normalization module 350 to capture the interactions between the different score sets. For example, if normalization module 350 provides three normalized variables (s1, s3, s3), then interactions generation module 360 creates three interaction variables s1*s2, s1 *s3 and s2*s3.

In another embodiment, fraud detection system 300 selects the top m interactions with the largest variance. In this embodiment, interactions generation module 360 computes the variance for each interaction based on its values and then selects the top m interactions with the largest variance.

Principal component analysis (PCA) transformation module 370 then transforms the normalized scores and creates linear combinations of the normalized variables, referred to herein as “PCA components.” For example, a PCA component may be “Factor_1 = S2+2*S1_Sqrt.”

PCA transformation module 370 performs dimensionality reduction by projecting each data point onto only a first few principal components to obtain lower-dimensional data while preserving as much of the data’s variation as possible. The principal components of a collection of points in a real coordinate space are a sequence of p unit vectors, where the i-th vector is the direction of a line that best fits the data while being orthogonal to the first i-1 vectors. The first principal component is equivalently defined as a direction that maximizes the variance of the projected data. The i-th principal component can be taken as a direction orthogonal to the first i-1 principal components that maximize the variance of the projected data. FIG. 6 shows an example of transforming normalized scatter plot 600 to PCA plot 650.

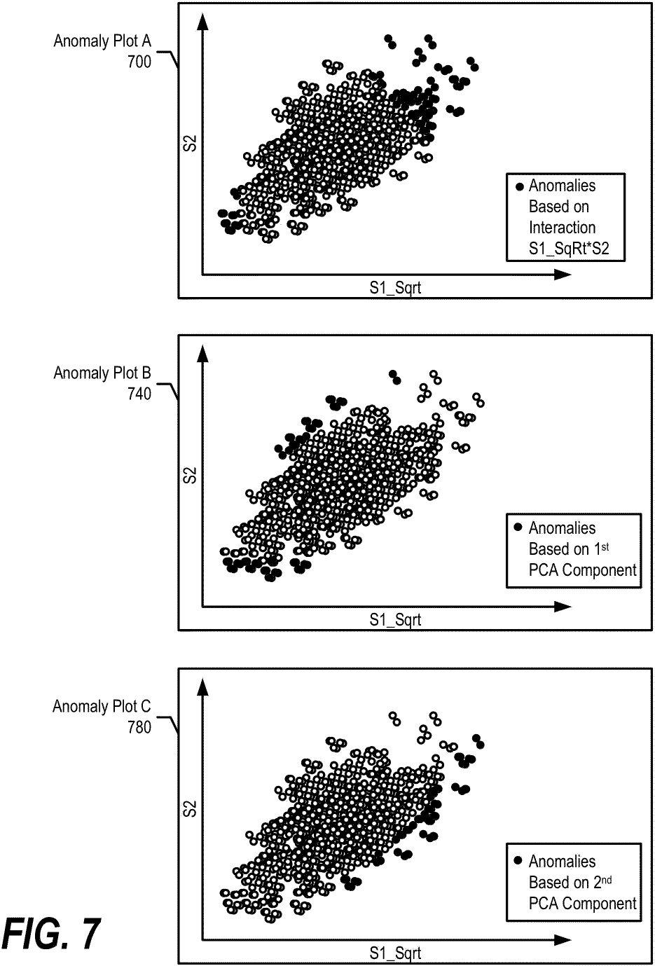

PCA transformation module 370 then selects the top n components (linear combinations of normalized variables) with the largest variance. New anomaly detection module 375 then identifies anomalies based on the top m interactions from interactions generation module 360, and identifies anomalies based on the top n components from PCA transformation module 370. In on embodiment, as shown in FIG. 7, new anomaly detection module 375 displays anomalies on plots based on relationships between normalized scores, which is different from historical ensemble approaches that analyze each score individually to detect anomalies.

Anomaly combination module 390 combines the anomalies from each of the anomaly methods and creates combined anomaly plot 395. In turn, a user evaluates combined anomaly plot 395 and selects particular anomalies for further analysis. In one embodiment, fraud detection system 300 identifies the top k anomalies in combined anomaly plot 395 for a user to evaluate. In this embodiment, fraud detection system 300 calculates the sum of an anomalous score for each record from the unsupervised models, the m anomaly scores for the interactions, and n scores from the PCA components to identify the top k records with the largest of sum of scores.

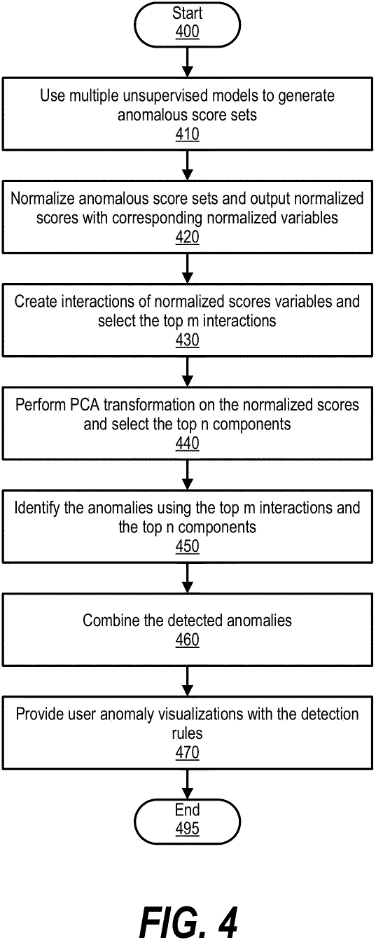

FIG. 4 is an exemplary flowchart showing steps taken to detect anomalies based on interactions and PCA components. FIG. 4 processing commences at 400 whereupon, at step 410, the process uses multiple unsupervised models (320 and 325) to compute their individual anomaly scores. In one embodiment, the process uses unsupervised models such as a k-means model, two-step clusters model, etc., to compute anomaly scores.

At step 420, the process normalizes the anomalous score variables from the unsupervised models and outputs normalized variables with corresponding normalized scores. In one embodiment, the process automatically applies transformations to the score variables to follow a normal distribution. For example, when the process receives two score variables (S1 and S2) from two unsupervised models, the process may transform the score variable S1 by a square root function to S1_SqRt, but does not transform the score variable S2 because the score variable S2 already follows a natural distribution (see FIG. 6 and corresponding text for further details). In turn, the process outputs normalized variables (S1_Sqrt, S2) and corresponding normalized scores.

At step 430, the process creates interactions of the normalized variables and selects the top m interactions. An interaction is product of two normalized variables, such as Interaction 1 = S1_SqRt*S2. In one embodiment, the process creates multiple interactions if there are multiple score variables from multiple unsupervised models.

In another embodiment, for each normalized variable, the process attempts many transformations and selects one normalization transformation that mostly follows a normal distribution based on a statistic test such as KS test. In this embodiment, after normalization, the process has two variables, S1_SqRt and S2, resulting in one interaction S1_SqRt*S2. In another embodiment, if there are multiple unsupervised models that generate multiple variables, the process may have more than two normalized variables and multiple interactions.

At step 440, the process performs PCA transformation on the normalized variables and selects the top n components. In one embodiment, the top n components are extracted according to large eigenvalues (variances). FIG. 6 shows an example where PCA plot 650 selects Factor_1 and Factor_2 as the top n components. In one embodiment, fraud detection system 300 selects multiple top components and plots every two components on a 2D graph, and/or plots every three components on a 3D graph.

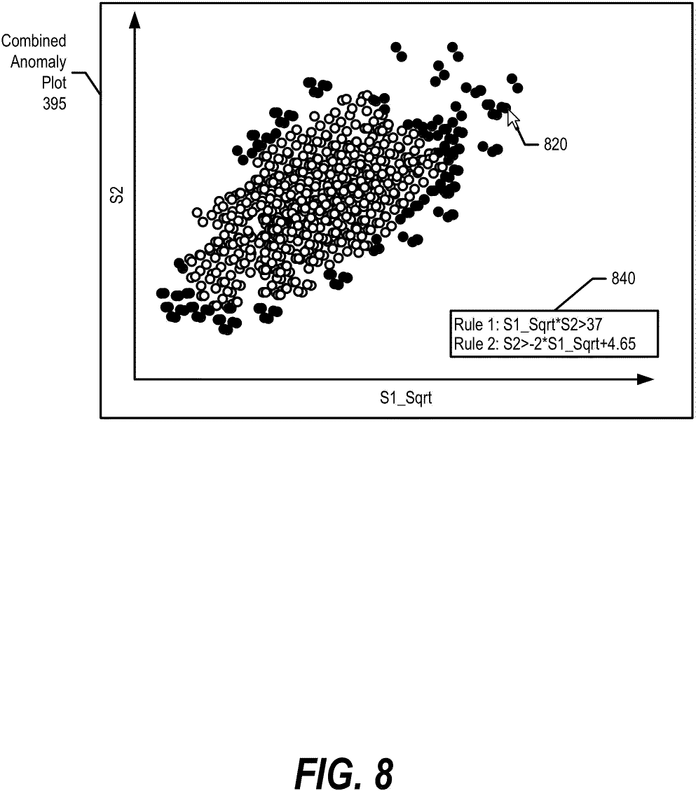

At step 450, the process identifies anomalies using the top m interactions and the top n components (See FIG. 7 and corresponding text for further details). At step 460, the process combines the detected anomalies into combined anomaly plot 395. At step 470, the process provides the user with combined anomaly plot 395 and provides detection rules to the user when the user selects a particular data point that indicate reasons that the data point is considered an anomaly (see FIG. 8 and corresponding text for further details). FIG. 4 processing thereafter ends at 495.

FIG. 5 is an exemplary diagram depicting table data that includes data records information, score sets, normalized scores, and interactions. Table 500 includes a list of records from data store 310, which includes record identifiers in column 510 and feature sets in columns 520. The feature sets in columns 520 may correspond to transaction information such as date, transaction amount, transfer recipient, location of transaction, etc.

Fraud detection system 300 inputs the data records into unsupervised models 1 320 and 2 325, which generate score set 1 330 and score set 2 340, respectively. Column 530 includes scores 1 320, and column 540 includes score set 2 340. Then, fraud detection system 300 feeds the anomalous scores from columns 530 and 540 into normalization module 350 to normalize the score sets if needed.

Normalization module 350, in one embodiment, computes the square root of the scores in column 530 to generate normalized scores for S1 in column 570 shown in table 550. Table 550 shows that fraud detection system 300 does not transform the S2 scores in column 540 because, in one embodiment, score set 2 340 follows a normal distribution. Once fraud detection system 300 normalizes the scores as needed, fraud detection system 300 creates interactions of the corresponding normalized variables. Column 590 shows interaction 1 (11) = S1_SqRt * S2. In other words, column 590 is the product of the values in column 570 with the values in column 540.

FIG. 6 is an exemplary diagram depicting fraud detection system 300 transforming a normalized scatter plot using principal component analysis (PCA). Normalized scatter plot 600 plots S1_Sqrt and S2 from columns 570 and 540 in table 550. Because normalized scatter plot 600 produces in an oblong field of data tilted upwards, normalized scatter plot 600 requires either rotating the data field or using a method that aligns itself to this variation, such as PCA (principal components analysis). Fraud detection system 300 performs PCA on features with oblong fields to assist in anomaly detection because, with oblong scatter plots, some records may not be considered as an anomaly based on each original score variable.

PCA plot 650 shows the results of performing PCA on normalized variables S1_Sqrt and S2, and plots the data points using the first two principal components “Factor_1” and “Factor_2”. In one embodiment, PCA transformation module 370 selects the top n components and displays every two components on a different plot.

FIG. 7 is an exemplary diagram showing multiple anomaly plots based on the top m interactions and the top n components. As discussed herein, fraud detection system 300 independently detects anomalies for each derived interaction and PCA component. In one embodiment, fraud detection system 300 determines the total number of plots by the number of normalized variables. In this embodiment, fraud detection system 300 may not show all the plots but instead allows a user to select any two normalized variables to display.

Anomaly plot A 700 shows the anomalies based on the S1_Sqrt*S2 interaction. Anomaly plot B 740 shows anomalies based on the first PCA component (Factor_1), and anomaly plot C 780 shows the anomalies based on second PCA component (Factor_2). Fraud detection system 300 then displays and highlights the anomalies for the user to review (see FIG. 8 and corresponding text for further details).

FIG. 8 is an exemplary diagram depicting a combination of the anomalies detected by fraud detection system 300. Combined anomaly plot 800 combines plots 700, 740, and 780 into a single two-dimensional plot for a user to analyze. In one embodiment, when the user uses cursor 820 to select a particular data point, fraud detection system 300 displays window 840, which includes rules violated by the selected data point to trigger an anomaly.

In one embodiment, when fraud detection system 300 determines that the anomaly is from an unsupervised model’s original anomaly score, fraud detection system 300 displays initial rules for each record. When fraud detection system 300 determines an anomaly from interactions or PCA components, fraud detection system 300 displays their corresponding rules. In this embodiment, a record may be considered an anomaly by one or more rules. Window 840 shows rule 1 and rule 2. Rule 1 (S1_Sqrt*S2>37) indicates the record is considered an anomaly by interaction anomaly detection on S1_Sqrt*S2. Rule 2 (S2>-2*S1_Sqrt+4.65) is based on a PCA component, which is “f1= S2+2*S1_Sqrt.” Fraud detection system 300 determines, based on analyzing the corresponding PCA plot, that a record should be considered an anomaly when S2+2*S1>4.65. As such, fraud detection system 300 creates a rule based on S2+2*S1>4.65, which translates to a rule of “S2>-2*S1_Sqrt+4.65.”

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
generating a plurality of anomaly score variables using a plurality of unsupervised models based on a set of data records;
normalizing the plurality of anomaly score variables into a plurality of normalized variables;
constructing at least one interaction based on a first one of the plurality of normalized variables and a second one of the plurality of normalized variables, wherein the first normalized variable corresponds to a first one of the plurality of anomaly score variables and the second normalized variable corresponds to a second one of the plurality of anomaly score variables;
detecting a set of anomalies based on the at least one interaction; and
transmitting the set of anomalies to a user.

2. The computer-implemented method of claim 1 further comprising:
constructing a plurality of interactions based on the plurality of normalized variables, wherein the plurality of interactions comprises the at least one interaction;
selecting a set of top m interactions from the plurality of interactions based on a variance of their corresponding interaction values; and
detecting the set of anomalies that correspond to the set of top m interaction equations.

3. The computer-implemented method of claim 1 further comprising:
in response to determining that a first one of the plurality of anomaly score variables fails to follow a normal distribution, applying a transformation function to the first anomaly score variable to transform the first anomaly score variable into the first normalized variable; and
generating a normalized scatter plot using the first normalized variable and the second normalized variable.

4. The computer-implemented method of claim 3 further comprising:
performing a principal component analysis (PCA) transformation on the normalized scatter plot based on a set of top n components from the PCA transformation;
detecting a different set of anomalies from the PCA transformation based on the set of top n components;
combining the different set of anomalies with the set of anomalies to create a combined set of anomalies; and
transmitting the combined set of anomalies to the user.

5. The computer-implemented method of claim 4 further comprising:
detecting a first subset of the different set of anomalies based on a first component from the set of top n components;
detecting a second subset of the different set of anomalies based on a second component from the set of top n components; and
combining the first subset of the different set of anomalies with the second subset of the different setoff anomalies into the different set of anomalies.

6. The computer-implemented method of claim 4 further comprising:
creating a combined anomalies plot based on the combined set of anomalies, wherein the combined anomalies plot comprises a plurality of data points that graphically identifies the combined set of anomalies;
transmitting the combined anomalies plot to the user;
receiving, from the user, a selection of one of the plurality of data points; and
displaying, to the user, a set of rules utilized in the determination that the selected data point is an anomaly.

7. The computer-implemented method of claim 6 further comprising:
wherein at least one of the set of rules comprises a PCA rule based on at least one of the top n components.

8. The computer-implemented method of claim 6 further comprising:
identifying a set of original anomalies from the plurality of anomaly score variables; and
adding the set of original anomalies into the combined anomalies plot.

9. An information handling system comprising:
one or more processors;
a memory coupled to at least one of the processors;
a set of computer program instructions stored in the memory and executed by at least one of the processors in order to perform actions of:
generating a plurality of anomaly score variables using a plurality of unsupervised models based on a set of data records;
normalizing the plurality of anomaly score variables into a plurality of normalized variables;
constructing at least one interaction based on a first one of the plurality of normalized variables and a second one of the plurality of normalized variables, wherein the first normalized variable corresponds to a first one of the plurality of anomaly score variables and the second normalized variable corresponds to a second one of the plurality of anomaly score variables;
detecting a set of anomalies based on the at least one interaction; and
transmitting the set of anomalies to a user.

10. The information handling system of claim 9 wherein the processors perform additional actions comprising:
constructing a plurality of interactions based on the plurality of normalized variables, wherein the plurality of interactions comprises the at least one interaction;
selecting a set of top m interactions from the plurality of interactions based on a variance of their corresponding interaction values; and
detecting the set of anomalies that correspond to the set of top m interaction equations.

11. The information handling system of claim 9 wherein the processors perform additional actions comprising:
in response to determining that a first one of the plurality of anomaly score variables fails to follow a normal distribution, applying a transformation function to the first anomaly score variable to transform the first anomaly score variable into the first normalized variable; and
generating a normalized scatter plot using the first normalized variable and the second normalized variable.

12. The information handling system of claim 11 wherein the processors perform additional actions comprising:
performing a principal component analysis (PCA) transformation on the normalized scatter plot based on a set of top n components from the PCA transformation;
detecting a different set of anomalies from the PCA transformation based on the set of top n components;
combining the different set of anomalies with the set of anomalies to create a combined set of anomalies; and
transmitting the combined set of anomalies to the user.

13. The information handling system of claim 12 wherein the processors perform additional actions comprising:
detecting a first subset of the different set of anomalies based on a first component from the set of top n components;
detecting a second subset of the different set of anomalies based on a second component from the set of top n components; and
combining the first subset of the different set of anomalies with the second subset of the different setoff anomalies into the different set of anomalies.

14. The information handling system of claim 12 wherein the processors perform additional actions comprising:
creating a combined anomalies plot based on the combined set of anomalies, wherein the combined anomalies plot comprises a plurality of data points that graphically identifies the combined set of anomalies;
transmitting the combined anomalies plot to the user;
receiving, from the user, a selection of one of the plurality of data points; and
displaying, to the user, a set of rules utilized in the determination that the selected data point is an anomaly.

15. The information handling system of claim 14 wherein at least one of the set of rules comprises a PCA rule based on at least one of the top n components.

16. The information handling system of claim 14 wherein the processors perform additional actions comprising:
identifying a set of original anomalies from the plurality of anomaly score variables; and
adding the set of original anomalies into the combined anomalies plot.

17. A computer program product stored in a computer readable storage medium, comprising computer program code that, when executed by an information handling system, causes the information handling system to perform actions comprising:
generating a plurality of anomaly score variables using a plurality of unsupervised models based on a set of data records;
normalizing the plurality of anomaly score variables into a plurality of normalized variables;
constructing at least one interaction based on a first one of the plurality of normalized variables and a second one of the plurality of normalized variables, wherein the first normalized variable corresponds to a first one of the plurality of anomaly score variables and the second normalized variable corresponds to a second one of the plurality of anomaly score variables;
detecting a set of anomalies based on the at least one interaction; and
transmitting the set of anomalies to a user.

18. The computer program product of claim 17 wherein the information handling system performs further actions comprising:
constructing a plurality of interactions based on the plurality of normalized variables, wherein the plurality of interactions comprises the at least one interaction;
selecting a set of top m interactions from the plurality of interactions based on a variance of their corresponding interaction values; and
detecting the set of anomalies that correspond to the set of top m interaction equations.

19. The computer program product of claim 17 wherein the information handling system performs further actions comprising:
in response to determining that a first one of the plurality of anomaly score variables fails to follow a normal distribution, applying a transformation function to the first anomaly score variable to transform the first anomaly score variable into the first normalized variable; and
generating a normalized scatter plot using the first normalized variable and the second normalized variable.

20. The computer program product of claim 19 wherein the information handling system performs further actions comprising:
performing a principal component analysis (PCA) transformation on the normalized scatter plot based on a set of top n components from the PCA transformation;
detecting a different set of anomalies from the PCA transformation based on the set of top n components;
combining the different set of anomalies with the set of anomalies to create a combined set of anomalies; and
transmitting the combined set of anomalies to the user.

21. The computer program product of claim 20 wherein the information handling system performs further actions comprising:
detecting a first subset of the different set of anomalies based on a first component from the set of top n components;
detecting a second subset of the different set of anomalies based on a second component from the set of top n components; and
combining the first subset of the different set of anomalies with the second subset of the different setoff anomalies into the different set of anomalies.

22. The computer program product of claim 20 wherein the information handling system performs further actions comprising:
creating a combined anomalies plot based on the combined set of anomalies, wherein the combined anomalies plot comprises a plurality of data points that graphically identifies the combined set of anomalies;
transmitting the combined anomalies plot to the user;
receiving, from the user, a selection of one of the plurality of data points; and
displaying, to the user, a set of rules utilized in the determination that the selected data point is an anomaly.

23. The computer program product of claim 22 wherein at least one of the set of rules comprises a PCA rule based on at least one of the top n components.

24. The computer program product of claim 22 wherein the information handling system performs further actions comprising:
identifying a set of original anomalies from the plurality of anomaly score variables; and
adding the set of original anomalies into the combined anomalies plot.

25. A computer-implemented method comprising:
generating a plurality of anomaly score variables using a plurality of unsupervised models based on a set of data records;
normalizing the plurality of anomaly score variables into a plurality of normalized variables;
performing a principal component analysis (PCA) transformation on the plurality of normalized variables, wherein the PCA transformation indicates a set of top n components;
detecting a set of anomalies from the PCA transformation based on the set of top n components; and
transmitting the set of anomalies to the user.
